(19) United States
(12) Patent Application Publication
(10) Pub. No.: US 2012/0106528 A1
(43) Pub. Date: May 3, 2012

(54) UNIFIED PROTOCOL STACK FOR COLOCATED WIRELESS TRANSCEIVERS

(75) Inventors: Leonardo W. ESTEVEZ, Rowlett, TX (US); Yanjun SUN, Richardson, TX (US); Ramanuja VEDANTHAM, Allen, TX (US); Ariton E. XHAFA, Plano, TX (US)

(73) Assignee: TEXAS INSTRUMENTS INCORPORATED, Dallas, TX (US)

(21) Appl. No.: 13/281,826

(22) Filed: Oct. 26, 2011

Related U.S. Application Data
(60) Provisional application No. 61/407,737, filed on Oct. 28, 2010.

(51) Int. Cl. H04W 92/00

(52) U.S. Cl. 370/338

(57) ABSTRACT

A system and method for accessing a wireless network via unified protocol stack. In one embodiment a wireless networking system includes a wireless device. The wireless device includes a first wireless transceiver, a second wireless transceiver, a processor, and a unified protocol stack. The first wireless transceiver is configured for communication via a first wireless network. The second wireless transceiver is configured for communication via a second wireless network. The unified protocol stack includes first protocols defined for accessing the first wireless network and second protocols defined for accessing the second wireless network. The unified protocol stack includes instructions that cause the processor to access the first wireless network via the first wireless transceiver using one of the second protocols.

### CROSS-REFERENCE TO RELATED APPLICATION

The present application claims priority to U.S. Provisional Patent Application No. 61/407,737, filed on Oct. 28, 2010 (Attorney Docket No. TI-70185PS); which is hereby incorporated herein by reference in its entirety.

### BACKGROUND

Mobile wireless devices may be equipped with any of number of different wireless technologies to access different networks. For example, a wireless device may be capable of accessing a wireless local area network (WLAN), a BLUETOOTH network, a ZIGBEE network, an ANT network, etc. Some wireless devices include more than one such wireless technology, thereby allowing the device to access a plurality of different wireless networks. Each radio system, corresponding to a wireless technology, included in a wireless device, generally includes one or more distinct protocol stacks. A protocol stack is a set of instructions that control the configuration of the device for network access, and controls the formatting and deformatting of data transferred via a network. The instructions of the protocol stack may be organized in layers corresponding to different protocols. Conventionally, an application interfaces to each different wireless network via a different protocol stack and corresponding application interface.

### SUMMARY

A system and method for accessing a wireless network via unified protocol stack are disclosed herein. In one embodiment a wireless networking system includes a wireless device. The wireless device includes a first wireless transceiver, a second wireless transceiver, a processor, and a unified protocol stack. The first wireless transceiver is configured for communication via a first wireless network. The second wireless transceiver is configured for communication via a second wireless network. The unified protocol stack includes first protocols defined for accessing the first wireless network and second protocols defined for accessing the second wireless network. The unified protocol stack includes instructions that cause the processor to access the first wireless network via the first wireless transceiver using one of the second protocols.

In another embodiment, a method includes selecting, by a wireless device, via a unified protocol stack of the wireless device, a configuration to apply to a first wireless network to which the wireless device is connected. The configuration selected is defined by a protocol of a second wireless network. The second wireless network is incompatible with the first wireless network. The first wireless network is configured, by the processor, to transfer data in accordance with the selected configuration.

In yet another embodiment, a computer-readable medium is encoded with instructions for a unified protocol stack. When executed the instructions cause a processor of a wireless device to receive at the unified protocol stack a data block for wireless transmission. The instructions also cause the processor to determine a transfer timing requirement of the data block, and to select, based on the requirement, one wireless transceiver of a plurality of wireless transceivers of the wireless device to use to transmit a data block. The instructions further cause the processor to transmit the data block via the selected transceiver. Each transceiver of the plurality of wireless transceivers communicates via one of a plurality of different and incompatible wireless networks.

### BRIEF DESCRIPTION OF THE DRAWINGS

For a detailed description of exemplary embodiments of the invention, reference will now be made to the accompanying drawings in which:

FIG. 1 shows a block diagram of a wireless network including a wireless device that incorporates a unified protocol stack in accordance with various embodiments;

FIG. 2 shows a block diagram of a wireless device including a unified protocol stack in accordance with various embodiments;

FIG. 3 shows a block diagram of a first unified protocol stack in accordance with various embodiments;

FIG. 4 shows a block diagram of a second unified protocol stack in accordance with various embodiments;

FIG. 5 shows a block diagram of a multi-hop mesh network formed from a plurality of wireless devices using wireless local area network transceivers in accordance with various embodiments; and

FIG. 6 shows a flow diagram for a method for sharing protocol features in a wireless device via a unified protocol stack in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of additional factors.

### DETAILED DESCRIPTION

The following discussion is directed to various embodiments of the invention. Although one or more of these embodiments may be preferred, the embodiments disclosed should not be interpreted, or otherwise used, to limit the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Wireless devices that incorporate multiple co-located radio technologies advantageously provide access to a corresponding number of different wireless networks. However, such devices subject to a number of issues. The use of different protocol stacks for each radio makes it difficult to employ applications developed for use with one wireless technology with a different wireless technology. For example, an application developed for BLUETOOTH may require major revision to be used with a wireless local area network (WLAN).

The multiple protocol stacks included in a wireless device may include similar features redundantly provided in each stack. Such redundancy is a waste of storage space, and also wastes development resources required to implement the redundant features. Furthermore, selection of one of the multiple radios to be applied in a particular application must take place at the application level. Consequently, the most appropriate radio for the data being transferred may not be selected, resulting in inefficient use of the wireless medium.

Embodiments of the present disclosure include a unified protocol stack that controls all of the different radios of a wireless device. The unified protocol stack is configured to provide access to a plurality of different wireless networks, and provides a number of advantages over the protocol stack per radio model conventionally employed. The unified stack can provide improved application portability by presenting a single consistent interface to all radios. The unified stack may also allow radio transceivers in the same device to share functionality with one another. Such sharing of functionality not only reduces memory footprint, but also creates new functionality not available in any individual radio. For example, the unified stack may allow use of the ZIGBEE mesh feature over WLAN radio, enabling a mesh WLAN network with much higher throughput than a ZIGBEE network.

Additionally, the unified stack may provide coordination of the various radios. The unified stack can coordinate use of the radios by selecting for use the radio most appropriate for a given task. In some embodiments, the unified stack may select a radio based on the transfer requirements of the data being transmitted. The unified stack may also coordinate radio use at either the device or network level to provide coexistence at the network-level, thereby reducing inter-network interference.

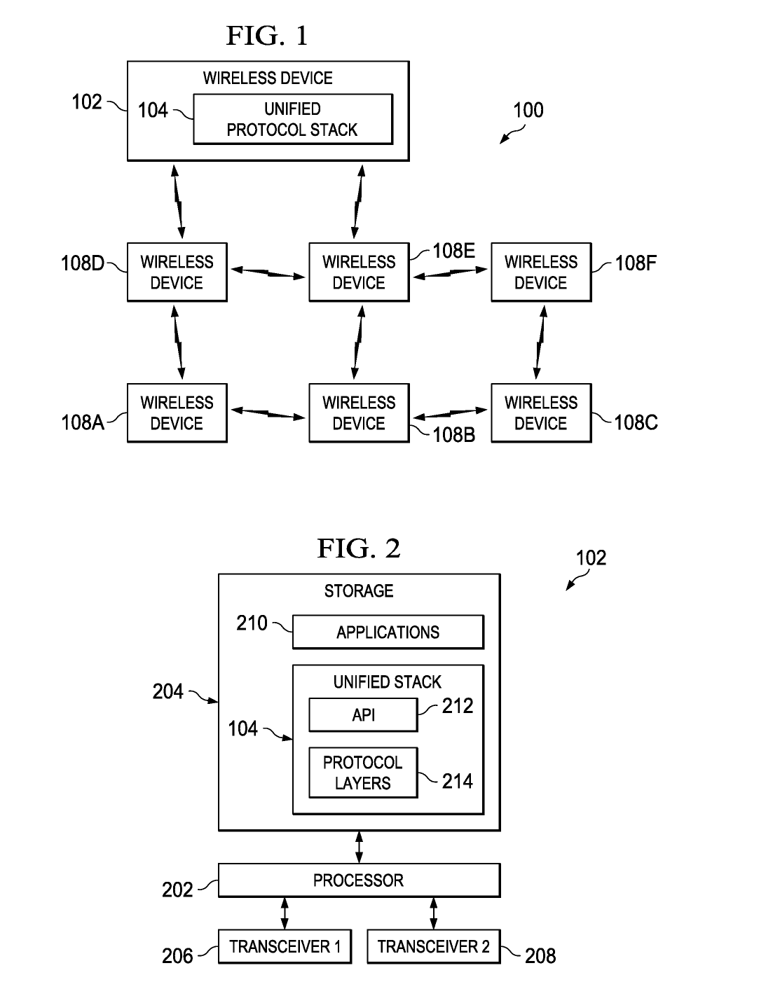

FIG. 1 shows a block diagram of a wireless network 100 including a wireless device 102 that incorporates a unified stack 104 in accordance with various embodiments. The wireless network 100 may include one or more different wireless networking technologies, for example, an IEEE 802.11 based WLAN, BLUETOOTH, ZIGBEE, ANT, etc. The wireless device 102 may be any of a wide variety of devices that communicate via the wireless network 100. The wireless device 102 is communicatively coupled to the wireless devices 108. In practice, the wireless network 100 may include any number of wireless devices 102, 108. Each wireless device 108 may also include the unified protocol stack 104 to manage the radio technologies incorporated in the device.

In the wireless network 100, the unified protocol stack 104 enhances the operation of the wireless devices 102, 108. For example, if the wireless devices 102, 108 include WLAN transceivers, and the unified protocol stack supports both WLAN and ZIGBEE, then the unified protocol stack 104 may configure the wireless device 102 to operate as part of a WLAN based mesh in accordance with the ZIGBEE protocol. Thereby, configuring the WLAN in a manner not defined by the WLAN protocol. Such a configuration may extend the range of the WLAN or provide other advantages over the point-to-point WLAN model. Similarly, other configurations and protocols not supported by one wireless networking standard may be applied to the network 100 based on a different standard supported by the unified protocol stack 104.

The unified protocol stack 104 also allows the wireless device 102 to select a radio for use based on the suitability of the radio for transfer of a given data block. For example, if the wireless devices 102, 108F include a WLAN transceiver and a ZIGBEE transceiver, and both the WLAN and ZIGBEE networks are available for use, then the unified protocol stack 104 may select the WLAN transceiver for transfer of large data blocks and select the ZIGBEE transceiver for transfer of infrequent control messages. Selecting WLAN communication can also reduce transfer latency by avoid the multiple hops between devices 102, 108E required by ZIGBEE. Thus, by selecting the appropriate radio for each data transfer, the unified stack 104 can optimize transfer latency and power consumption of the wireless devices 102 108. The selective use of the two redundant transceivers can also provide increased communication reliability and efficiency. For example, the unified protocol stack 104 can enable reception of packets on a first wireless network using one wireless protocol and retransmission of that packet on a second wireless network using a different wireless protocol. Such capability is advantageous in multiple scenarios. In a scenario where the first network experiences a problem that causes a transmission failure, the second network may be unaffected and consequently retransmissions over the second network tend to be more reliable. In another scenario, such redundancy can also enable efficient data exchange. For example, if data packets are initially transmitted without automatic repeat request (ARQ) via a first network, then when a receiver detects a missing packet, the receiver can request retransmission of the packet via the second network. Such capability can be especially useful when retransmissions occur infrequently, because the first network can operate without ARQ.

When wireless devices 102, 108 are communicating via different transceivers, interference between the transceivers can reduce throughput and increase latency and power consumption of the wireless devices 102, 108. To reduce such interference, some embodiments of the unified protocol stack 104 coordinate the activities of the transceivers in each wireless device 102, 108. For example, embodiments of the unified protocol stack 104 can communicate among themselves to effect adjustment of the medium access schedules of the various wireless transceivers. The unified protocol stack 104 may implement such adjustment using, for example, CTS-to-self transmissions, WI-FI DIRECT power save features, IEEE 802.11 power save, TDLS power save, and network traffic shaping.

FIG. 2 shows a block diagram of the wireless device 102 including a unified stack 104 in accordance with various embodiments. The wireless device 102 includes a processor 202, a first transceiver 206, a second transceiver 208, and storage 204. The first and second transceivers 206, 208 comprise circuitry for transmitting and receiving wireless signals on different wireless networks. For example, the first transceiver 206 may be configured for WLAN access, and the second transceiver 208 may be configured to access a ZIGBEE network, and ANT network, BLUETOOTH network, etc. Each transceiver 206, 208 may include circuitry, such as filters, amplifiers, modulators, demodulators, signal generators, etc. suitable for accessing a respective wireless network.

The processor 202 is coupled to the transceivers 206, 208. Some embodiments of the wireless device 102 may include more than one processor 102. The processor 102 is configured to execute instructions retrieved from storage 204. Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Those skilled in the art understand that processors execute software instructions, and that software instructions alone are incapable of performing a function. Therefore, any reference to a function performed by software, or to software performing a function is simply a shorthand means for stating that the function is performed by a processor executing the software, or a processor executing the software performs the function.

The storage 204 is coupled to the processor 202. The storage 204 is a computer-readable medium that stores software instructions for retrieval and execution by the processor 202. A computer readable storage medium comprises volatile storage such as random access memory, non-volatile storage (e.g., a hard drive, an optical storage device (e.g., CD or DVD), FLASH storage, read-only-memory), or combinations thereof. The software programs residing in the storage 204 include various applications 210 and the unified protocol stack 104. An operating system and/or other programming executable by the processor 202, and data manipulated by the processor 202 (e.g., data blocks wirelessly transferred via the transceivers 206,208) may also be stored in the storage 204. The applications 210 may define the general operation of the wireless device 102. For example, the wireless device 102 may be configured to monitor its environment via sensors included in the wireless device 102, process the sensor data, and wirelessly transfer the processed sensor data to another wireless device 108. These operations are performed and/or initiated by an application 210.

The application programs 210 utilize the services of the unified protocol stack 104 to transfer data via the wireless transceivers 206, 208. The unified protocol stack 104 includes an application programming interface (API) 212 and various protocol layers 214. The applications 210 access the unified protocol stack 104 via the API 212. The API 212 provides a single point of access to wireless services of the unified protocol stack 104 that is consistent across and requires no differentiation between or selection of a wireless transceiver 206, 208. For example, if an application 210 provides a data block to the unified protocol stack 104 via the API 212, the application 210 need not specify which of the transceivers 206, 208 is to be used to perform the transfer. Instead, the API 212, or a lower layer of the unified protocol stack 104 can determine which of the transceivers 206, 208 is most suitable to transfer the data block.

Suitability of a transceiver 206, 208 with regard to a particular data transfer may be determined based on the attributes of the data block and the protocols applied to data transferred via each transceiver 206, 208. Embodiments of the unified protocol stack 104 may evaluate such factors as the transfer rates, overhead, and power-per-bit of each transceiver 206 when compared to the data block size, data block transfer latency requirements, and the advantages of minimizing power consumption of the wireless device 102. For example, if the first transceiver 206 is configured for WLAN access, and the second transceiver 208 is configured for ZIGBEE access, then the unified protocol stack 104 may select the transceiver 206 to transfer a large block requiring low latency, and conversely may select the transceiver 208 to transfer a small block with a less stringent latency requirement. In some embodiments, the unified protocol stack 104 may select a transceiver 206, 208 based at least in part on the power (e.g., power-per-bit) consumed by the transceiver to transfer the packet. For example, the cumulative power required to transfer a large data block via a slower ZIGBEE transceiver 208 may exceed the power required to transfer the data block in much shorter time via the WLAN transceiver 206, while the ZIGBEE transceiver 208 may offer lower power for transferring smaller data blocks.

After the unified protocol stack 104 has selected a transceiver 206, 208 through which to execute a transfer, the unified protocol stack 104 may perform the transfer entirety via the selected transceiver. For example, if the transceiver 206 is selected to perform a transfer, no operations (e.g., initialization or control operations) are performed by the transceiver 208 to accomplish the transfer. The unified protocol stack 104 operates each transceiver 206, 208 independently of all other transceivers.

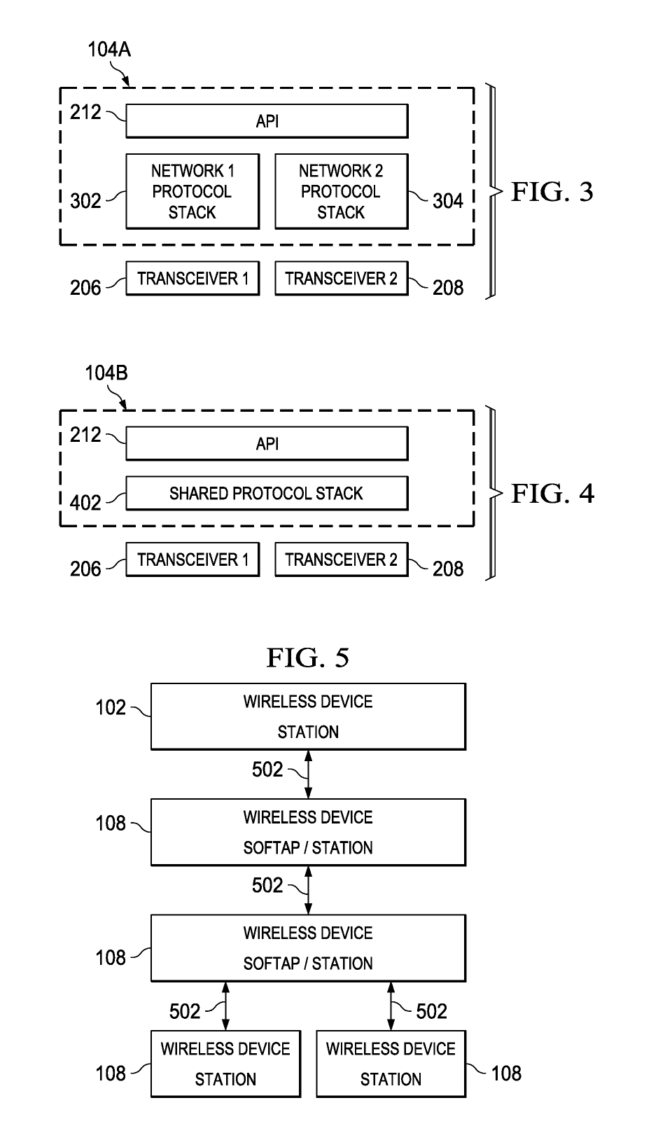

FIG. 3 shows one embodiment of a unified protocol stack 104A which may be a variant of the unified protocol stack 104. The unified protocol stack 104A includes the API 212, a first set of protocol stack layers 302, and a second set of protocol stack layers 304. The API 212 selects which of the transceivers 206, 208 is most suitable for transfer of a given data block as explained above, and the protocol stack layers 302, 304 execute the transfer via the selected transceiver 206, 208. The protocol stack layers 302 configure the transceiver 206 and perform formatting for data transfer via the transceiver 206. The protocol stack layers 304 configure the transceiver 208 and perform formatting for data transfer via the transceiver 208. Thus, the unified protocol stack 104A provides selection of a transceiver independent of the applications 210.

FIG. 4 shows an embodiment of a unified protocol stack 104B, which may be a variant of the unified protocol stack 104. The unified protocol stack 104B includes the API 212, and a shared set of protocol stack layers 402. The protocol stack layers 402 include the configuration and formatting features to use both of the transceivers 206, 208, and may apply the features to either transceiver 206, 208. By cross-applying the features of the transceivers 208, 208, the unified protocol stack 104B creates network functionality and/or performance not included in either of the conventional distinct protocol stacks used with the transceivers 206, 208. For example, the protocol stack layers 402 may configure the WLAN transceiver 206 to operate in multi-hop mesh network as defined for the ZIGBEE transceiver 206, thereby creating a high-throughput mesh network not defined by either of the convention WLAN or ZIGBEE standards or protocol stacks. Embodiments of the unified protocol stack 104B may share various protocol features between the transceivers 206, 208, and thus across the networks formed by the transceivers 206, 208. The unified protocol stack 104B also provides transceiver selection transparent to the applications 210 as described with regard to the unified protocol stack 104A. When a packet traverses multiple networks with incompatible frame formats, the unified protocol stack 104B can also translate the formats in a way that is transparent to upper layers.

FIG. 5 shows an embodiment of a multi-hop mesh network formed from a plurality of wireless devices 102, 108 including WLAN transceivers in accordance with various embodiments. Each wireless device 102, 108 includes a unified protocol stack 104B operable to control WLAN and ZIGBEE transceivers. The unified protocol stack 402 configures each wireless device 102, 108 having connections to multiple other wireless devices 102, 108 to operate as a soft access point and a station (e.g., in accordance with the WIFI DIRECT standard), in order to create point-to-point connections with neighboring nodes as needed for routing in a mesh network. The unified protocol stack 104B passes received packets to a next wireless device 102, 108 in accordance with the ZIGBEE mesh protocol to provide connection over multiple hops.

The unified protocol stack 104B may also improve the throughput, latency, and power consumption of the wireless network 100, and of the wireless device 102 operating in the co-existing wireless networks using the transceivers 206, 208. Because the unified protocol stack 104B controls both of the transceivers 206, 208, the unified protocol stack 104B controls the medium access schedules of the transceivers 206, 208. Consequently, the unified protocol stack 104B can schedule operation of the transceivers 206, 208 to avoid inter-transceiver interference. Additionally, the unified protocol stack 104B can wirelessly communicate (e.g., via messages conveying medium access timing information) with an instance of the unified protocol stack 104B in another wireless device to coordinate medium access by the different transceivers 206, 208 across the network 100 to reduce interference network wide.

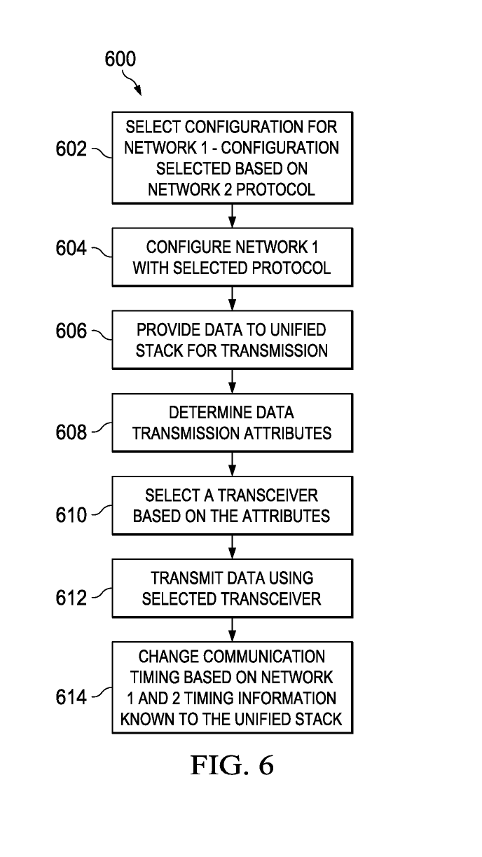

FIG. 6 shows a flow diagram for a method 600 for sharing protocol features in a wireless device 102 in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600, as well as other operations described herein, can be performed by the processor 202 of a wireless device 102, 108 executing instructions stored in a computer readable medium (e.g., storage 204).

In block 602, the wireless device 102, via the unified protocol stack 104, selects a configuration for the transceiver 206. That is, the unified protocol stack 104 determines how a network associated with the transceiver 206 is to be configured. The unified protocol stack 104 may select a configuration from any of a number of configurations associated with either transceiver 206 or 208. In block 602, the unified protocol stack 104 selects a configuration for transceiver 206 from the configurations defined by the protocols of transceiver 208. The selected protocol may be conventionally undefined with regard the transceiver 208.

In block 604, the unified protocol stack 104 configures the transceiver 206 in accordance with the selected configuration. For example, the unified protocol stack 104 may configure the transceiver 206 (e.g., a WLAN transceiver) for multi-hop mesh operation in accordance with a ZIGBEE protocol associated with transceiver 208.

In block 606, an application 210 provides a data block to the unified protocol stack 104 for wireless transfer to a different wireless device 108. The application 210 need not specify a transceiver 206, 208 or network via which to transfer the data block. The unified protocol stack 104 determines the attributes of the data block in block 608. The attributes may include various delivery requirements of the data block, such as latency and/or throughput.

In block 610, the unified protocol stack compares the transfer requirements of the data block to the transfer capabilities of the various transceivers 206, 208 included in the wireless device 102, and selects a transceiver 206, 208 based on the comparison. In some embodiments, the unified protocol stack 104 selects the transceiver 206, 208 that meets the transfer requirements of the data block and consumes the least power to perform the transfer (i.e., the least transfer power-per-bit). Because the wireless networks accessed by the transceivers 206, 208 may be at least partially coextensive and redundant, the unified protocol stack 104 may also select a transceiver based on the operational state of the transceivers. Consequently, if the transceiver 208 is inoperative or performing poorly, then the unified protocol stack 104 may selected the transceiver 206. The data block is wirelessly transferred to its destination via the selected transceiver in block 612.

In block 614, the unified protocol stack 104 compares the transfer schedules of the co-located transceivers 206, 208, and adjusts the communication schedules of at least one of the transceivers 206, 208 to reduce inter-network conflict identified by the comparison. Some embodiments wirelessly transfer information indicative of the transfer scheduling to other wireless devices 102, 108, and each wireless device 102, 108 adjusts its transfer schedule to reduce inter-network interference.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless networking system, comprising:
a wireless device, comprising:
a first wireless transceiver configured for communication via a first wireless network;
a second wireless transceiver configured for communication via a second wireless network;
a processor; and
a unified protocol stack that comprises:
first protocols defined for accessing the first wireless network;
second protocols defined for accessing the second wireless network; and
instructions that cause the processor to access the first wireless network via the first wireless transceiver using one of the second protocols.

2. The wireless networking system of claim 1, wherein the unified protocol stack causes the processor to select one of the first and second transceivers for use based on an attribute of a data block to be wirelessly transferred.

3. The wireless networking system of claim 2, wherein the attribute comprises at least one of a latency requirement of the data block and a throughput requirement of the data block.

4. The wireless networking system of claim 2, wherein the unified protocol stack causes the processor to select for use one of the first and second transceivers independent of an application using the processor to wirelessly transfer data.

5. The wireless networking system of claim 1, wherein the unified protocol stack causes the processor to select one of the first and second transceivers for use based on relative power-per-bit-transmitted consumed by the first and second transceivers.

6. The wireless networking system of claim 1, wherein the unified protocol stack causes the processor to provide a single interface for access of the first wireless network and access of the second wireless network.

7. The wireless networking system of claim 1, wherein the first wireless transceiver comprises one of a wireless local area network transceiver and a first wireless personal area network transceiver, and the second transceiver comprises a second wireless personal area network transceiver.

8. The wireless networking system of claim 1, wherein the unified protocol stack causes the processor to access the first wireless network as a mesh network and the first protocols do not define a mesh network.

9. The wireless networking system of claim 1, wherein communication on the first wireless network interferes with communication on the second wireless network, and the unified protocol stack causes the processor to schedule communication on the first and second wireless networks to reduce interference.

10. The wireless networking system of claim 1, wherein the unified protocol stack causes the processor to select one of the first and second transceivers to use based on an operational status of each of the transceivers.

11. The wireless networking system of claim 1, wherein the unified protocol stack causes the processor to receive a packet on the first wireless network using a first wireless protocol and retransmit the packet on the second wireless network using a different wireless protocol.

12. The wireless networking system of claim 1, wherein the unified protocol stack causes the processor to translate a format of a packet based on the packet traversing different wireless networks.

13. The wireless networking communication system of claim 1, further comprising a plurality of wireless communication devices configured to communicate with the wireless device via at least one of the first wireless network and the second wireless network.

14. A method, comprising:
selecting, by a wireless device, via a unified protocol stack of the wireless device, a configuration to apply to a first wireless network to which the wireless device is connected, the configuration selected defined by a protocol of a second wireless network that is incompatible with the first wireless network;
configuring the first wireless network to transfer data in accordance with the selected configuration.

15. The method of claim 14, further comprising:
providing a data block for transmission by the wireless device to a unified protocol stack through which the wireless device controls a plurality of wireless transceivers, each of the wireless transceivers used to access a different wireless network;
determining, by the unified protocol stack, an attribute of the data block;
selecting, by the unified protocol stack, based on the attribute, one transceiver of the plurality of wireless transceivers to use to transmit the data block;
transmitting the data block via the selected transceiver.

16. The method of claim 15, wherein the attribute comprises at least one of a latency requirement of the data block, and a throughput requirement of the data block.

17. The method of claim 15, wherein the selecting is based on relative power-per-bit-transmitted consumed by the each of the plurality of wireless transceivers.

18. The method of claim 14, wherein the selected configuration is a mesh, and protocols defined for the first wireless network do not include a mesh configuration.

19. The method of claim 14, further comprising changing, by the wireless device, communication timing of at least one of the first wireless network and the second wireless network to reduce interference between the first and second networks; wherein the changing is based on communication timing information provided by the unified protocol stack that controls wireless device access to the first and second networks.

20. The method of claim 14, further comprising:
receiving a packet on the first wireless network using a first wireless protocol; and
retransmitting the packet on a second wireless network using a different wireless protocol.

21. The method of claim 14, further comprising translating a format of a packet based on the packet traversing different wireless networks.

22. A computer-readable medium encoded with instructions for a unified protocol stack that when executed cause a processor of a wireless device to:
receive at the unified protocol stack a data block for wireless transmission;
determine a transfer timing requirement of the data block;
select, based on the requirement, one wireless transceiver of a plurality of wireless transceivers of the wireless device to use to transmit a data block;
transmit the data block via the selected transceiver;
wherein each transceiver of the plurality of wireless transceivers communicates via one of a plurality of different and incompatible wireless networks.

23. The computer-readable medium of claim 22, further encoded with instructions for the unified protocol stack that when executed cause the processor to select the one wireless transceiver based on relative power-per-bit-transmitted consumed by the each of the plurality of wireless transceivers.

24. The computer-readable medium of claim 22, further encoded with instructions for the unified protocol stack that when executed cause the processor to configure the wireless device for operation in each of the wireless networks, and to share configurations provided by the unified protocol stack across the networks; wherein a first network of the plurality of wireless networks is configured for operation based on a configuration defined by a second network of the plurality of wireless networks.

25. The computer-readable medium of claim 24, further encoded with instructions for the unified protocol stack that when executed cause the processor to configure the first network as a mesh network, wherein protocols defined for the first network do not define a mesh network.

26. The computer-readable medium of claim 22, further encoded with instructions for the unified protocol stack that when executed cause the processor to change communication timing of at least one of the plurality of wireless networks to reduce interference between the plurality of wireless networks; wherein the changing is based on communication timing information provided by the unified protocol stack.

27. The computer-readable medium of claim 22, further encoded with instructions for the unified protocol stack that when executed cause the processor to receive a packet on a first wireless network using a first wireless protocol and retransmit the packet on the second wireless network using a different wireless protocol.

28. The computer-readable medium of claim 22, further encoded with instructions for the unified protocol stack that when executed cause the processor to translate a format of a packet based on the packet traversing different wireless networks.
